(19) United States
(12) Patent Application Publication
(10) Pub. No.: US 2014/0178204 A1
(43) Pub. Date: Jun. 26, 2014

(54) WIND TURBINE ROTOR BLADES WITH FIBER REINFORCED PORTIONS AND METHODS FOR MAKING THE SAME

(71) Applicant: GENERAL ELECTRIC COMPANY, Schenectady, NY (US)

(72) Inventors: Jamie Thomas Livingston, Simpsonville, SC (US); Jan Bakhuis, Nijverdal (NL)

(73) Assignee: General Electric Company, Schenectady, NY (US)

(21) Appl. No.: 13/723,337

(22) Filed: Dec. 21, 2012

(51) Int. Cl. F03D 1/06

(52) U.S. Cl. CPC F03D 1/0675
USPC 416/230; 29/889.7

(57) ABSTRACT

Methods of manufacturing a fiber reinforced portion of a wind turbine rotor blade include disposing a continuous fiber mat adjacent a prefabricated layer, wherein the continuous fiber mat comprises randomly arranged reinforcing fibers and wherein the prefabricated layer comprises reinforcing fibers and a cured polymeric resin. The method further includes disposing a structural layer adjacent the continuous fiber mat opposite the prefabricated layer, wherein the structural layer comprises reinforcing fibers. The method then includes infusing a polymeric resin through at least the continuous fiber mat and curing the resin to form the fiber reinforced portion of the wind turbine rotor blade.

### BACKGROUND OF THE INVENTION

The subject matter disclosed herein relates generally to wind turbines, and more particularly to wind turbine rotor blades with fiber reinforced portions.

Recently, wind turbines have received increased attention as an environmentally safe and relatively inexpensive alternative energy source. With this growing interest, considerable efforts have been made to develop wind turbines that are reliable and efficient.

Generally, a wind turbine includes a rotor having multiple blades. The rotor is mounted on a housing or nacelle, which is positioned on top of a truss or tubular tower. Utility grade wind turbines (i.e., wind turbines designed to provide electrical power to a utility grid) can have large rotors (e.g., 30 or more meters in diameter). Blades on these rotors transform wind energy into a rotational torque or force that drives one or more generators, rotationally coupled to the rotor through a gearbox or directly coupled to the rotor. The gearbox, when present, steps up the inherently low rotational speed of the turbine rotor for the generator to efficiently convert mechanical energy to electrical energy, which is fed into a utility grid.

Known wind turbine blades are fabricated by infusing a resin into a fiber wrapped core. However, because some sections of the blade are thicker to accommodate high loads, known methods of infusing resins into thick parts do not always produce a defect free part within a cycle time that is no longer than the pot life of the infusion resin. One problem that can occur is the formation of dry spots where the infused resin has not reached. Some known solutions to these problems are to use added pre and/or post processes to infuse resin into dry spots. However, these processes typically result in increased direct labor costs, increased part cycle time, and increased facilitation by machines or equipment for the additional processing.

Accordingly, alternative wind turbine rotor blades having fiber reinforced portions, and methods for making the same, would be welcomed in the art.

### BRIEF DESCRIPTION OF THE INVENTION

In one embodiment, a method is disclosed of manufacturing a fiber reinforced portion of a wind turbine rotor blade. The method includes disposing a continuous fiber mat adjacent a prefabricated layer, wherein the continuous fiber mat comprises randomly arranged reinforcing fibers and wherein the prefabricated layer comprises reinforcing fibers and a cured polymeric resin. The method further includes disposing a structural layer adjacent the continuous fiber mat opposite the prefabricated layer, wherein the structural layer comprises reinforcing fibers. The method then includes infusing a polymeric resin through at least the continuous fiber mat and curing the resin to form the fiber reinforced portion of the wind turbine rotor blade.

In another embodiment, a method is disclosed of manufacturing a fiber reinforced portion of a wind turbine rotor blade. The method includes disposing a structural layer adjacent a prefabricated layer, wherein the structural layer comprises reinforcing fibers and wherein the prefabricated layer comprises reinforcing fibers and a cured polymeric resin. The method further includes disposing a continuous fiber mat adjacent the structural layer opposite the prefabricated layer, wherein the continuous fiber mat comprises randomly arranged reinforcing fibers. The method then includes infusing a polymeric resin through at least the continuous fiber mat and curing the resin to form the fiber reinforced portion of the wind turbine rotor blade.

In yet another embodiment, a wind turbine rotor blade comprising a fiber reinforced portion is disclosed. The fiber reinforced portion includes a prefabricated layer comprising reinforcing fibers and a cured polymeric resin, a continuous fiber mat adjacent the prefabricated layer, the continuous fiber mat comprising randomly arranged reinforcing fibers, and a polymer resin infused through at least the continuous fiber mat.

These and additional features provided by the embodiments discussed herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 is a side elevation schematic illustration of an exemplary configuration of a wind turbine according to one or more embodiments shown or described herein;

FIG. 2 is an exploded sectional illustration of one embodiment of a portion of the fiber reinforced section of one of the wind turbine rotor blades shown in FIG. 1 according to one or more embodiments shown or described herein;

FIG. 3 is an exploded sectional illustration of another embodiment of a portion of the fiber reinforced section of one of the wind turbine rotor blades shown in FIG. 1 according to one or more embodiments shown or described herein;

FIG. 4 is an exploded sectional illustration of another embodiment of a portion of the fiber reinforced section of one of the wind turbine rotor blades shown in FIG. 1 according to one or more embodiments shown or described herein;

FIG. 5 is an exploded sectional illustration of another embodiment of a portion of the fiber reinforced section of one of the wind turbine rotor blades shown in FIG. 1 according to one or more embodiments shown or described herein; and,

FIG. 6 is an exemplary method of manufacturing a fiber reinforced portion of a wind turbine rotor blade according to one or more embodiments shown or described herein.

### DETAILED DESCRIPTION OF THE INVENTION

A method of fabricating fiber reinforced portions of a wind turbine rotor blade is described below in detail. The method uses the addition of mats formed from randomly arranged reinforcing fibers adjacent preformed layers and/or other structural layers. The random fiber mats facilitate the infusion of a polymeric resin throughout the thickness of the fiber reinforced portion of the blade and the elimination of “dry spots” in the structure. The method reduces cycle times and cost by eliminating the need for secondary processes of building up thick sections of the wind turbine blade, e.g., the root section.

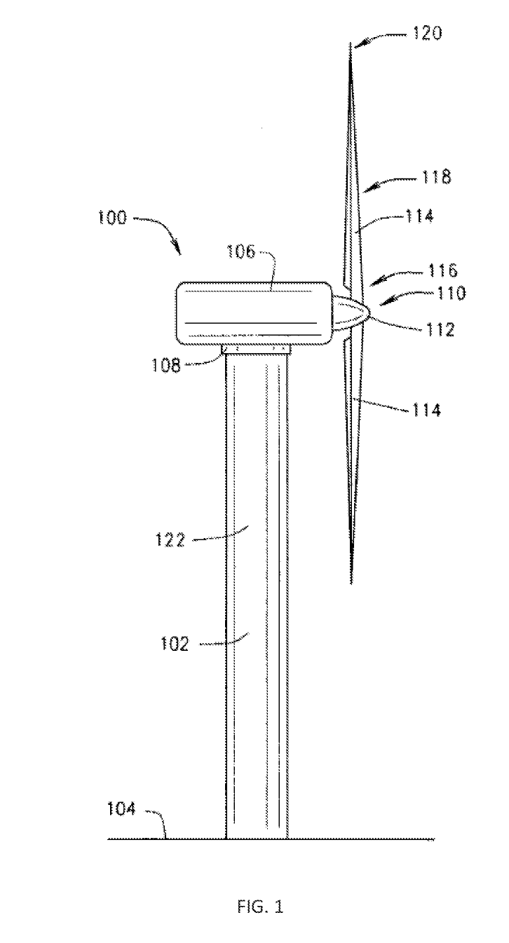

Referring to the drawings, FIG. 1 is a side elevation schematic illustration of a wind turbine 100, such as, for example, a horizontal axis wind turbine. Wind turbine 100 includes a tower 102 extending from a supporting surface 104, a nacelle 106 mounted on a bedframe 108 of tower 102, and a rotor 110 coupled to nacelle 106. Rotor 110 includes a hub 112 and a plurality of rotor blades 114 coupled to hub 112. In the exemplary embodiment, rotor 110 includes three rotor blades 114. In an alternative embodiment, rotor 110 includes more or less than three rotor blades 114. Each rotor blade 114 includes a root portion 116, which connects rotor blade 114 to hub 112, a main body portion 118 and a tip portion 120. In the exemplary embodiment, tower 102 is fabricated from tubular steel and includes a cavity 122 extending between supporting surface 104 and nacelle 106. In an alternate embodiment, tower 102 is a lattice tower.

Various components of wind turbine 100, in the exemplary embodiment, are housed in nacelle 106 atop tower 102 of wind turbine 100. The height of tower 102 is selected based upon factors and conditions known in the art. In some configurations, one or more microcontrollers in a control system are used for overall system monitoring and control including pitch and speed regulation, high-speed shaft and yaw brake application, yaw and pump motor application and fault monitoring. Alternative distributed or centralized control architectures are used in alternate embodiments of wind turbine 100. In the exemplary embodiment, the pitches of blades 114 are controlled individually. Hub 112 and blades 114 together form wind turbine rotor 110. Rotation of rotor 110 causes a generator (not shown in the figures) to produce electrical power.

In use, blades 114 are positioned about rotor hub 112 to facilitate rotating rotor 110 to transfer kinetic energy from the wind into usable mechanical energy. As the wind strikes blades 114, and as blades 114 are rotated and subjected to centrifugal forces, blades 114 are subjected to various bending moments. As such, blades 114 deflect and/or rotate from a neutral, or non-deflected, position to a deflected position. Moreover, a pitch angle of blades 114 can be changed by a pitching mechanism (not shown) to facilitate increasing or decreasing blade 114 speed, and to facilitate reducing tower 102 strike.

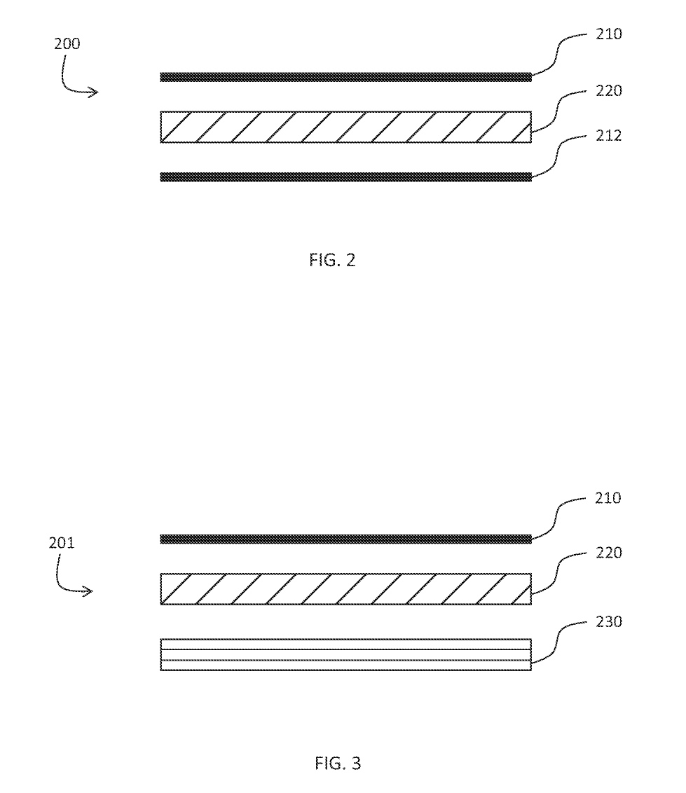

Referring now to FIGS. 2-5, fiber reinforced portions of wind turbine rotor blades are illustrated according to various exemplary embodiments. With specific reference to FIG. 2, the fiber reinforced portion 200 generally comprises a prefabricated layer 210 and a continuous fiber mat 220. The prefabricated layer 210 comprises reinforcing fibers and cured polymeric resin. The reinforcing fibers can comprise any fibers suitable for providing structural support to a wind turbine 100 rotor blade 114. For example, reinforcing fibers include, but are not limited to, glass fibers, graphite fibers, carbon fibers, polymeric fibers, ceramic fibers, aramid fibers, kenaf fibers, jute fibers, flax fibers, hemp fibers, cellulosic fibers, sisal fibers, coir fibers and combinations thereof. The polymeric resins can comprise any resin suitable for being infused into the reinforcing fibers and subsequently cured to produce a structurally rigid structure. For example, polymeric resins include, but are not limited to, vinyl ester resins, epoxy resins, polyester resins, and combinations thereof.

The continuous fiber mat 220 comprises randomly arranged reinforcing fibers. The randomly arranged reinforcing fibers allow the infusion of resin so that the resin can be better distributed throughout the entirety of the fiber reinforced portion 200 during manufacturing. Similar to above, the reinforcing fibers of the continuous fiber mat 220 can comprise any fibers suitable for providing structural support to a wind turbine 100 rotor blade 114. For example, reinforcing fibers include, but are not limited to, glass fibers, graphite fibers, carbon fibers, polymeric fibers, ceramic fibers, aramid fibers, kenaf fibers, jute fibers, flax fibers, hemp fibers, cellulosic fibers, sisal fibers, coir fibers and combinations thereof. In some embodiments, the reinforcing fibers in the continuous fiber mat 220 can comprise the same type of reinforcing fibers in the prefabricated layer 210. In other embodiments, the reinforcing fibers in the continuous fiber mat 220 can comprise different types of reinforcing fibers than in the prefabricated layer 210.

Referring to FIGS. 2 and 3, the fiber reinforced portion 200 and 201 can further comprise an additional structural layer 230. The structural layer 230 comprises reinforcing fibers similar to or the same as those found in the prefabricated layer 210 and/or the continuous fiber mat 220. In some embodiments, the structural layer 230 comprises continuous glass fibers. In some embodiments, the structural layer 230 comprises continuous carbon fibers. In even some embodiments, the structural layer 230 may comprise a second prefabricated layer 212 (such as illustrated in FIG. 2) such that the structural layer 230 also comprises cured polymeric resin.

The structural layer 230 can have a higher reinforcing fiber density than the continuous fiber mat 220. The reinforcing fiber density refers to the amount of reinforcing fiber present in a given volume. Thus, structural layers 230 comprising woven, stitched or otherwise aligned reinforced fibers can have a higher reinforcing fiber density than the continuous fiber mat 220 with its randomly arranged reinforcing fibers. The lower reinforcing fiber density of the continuous fiber mat 220 can allow for increased infusion of resin into the fiber reinforced portion 200 and 201 while the higher reinforcing fiber density of the structural layer 230 can provide greater structural support to the fiber reinforced portion 200 and 201. The combination of the prefabricated layer 210, continuous fiber mat 220 and structural layer 230 allows for the quicker and more efficient manufacturing of thicker fiber reinforced portions 200 and 201 while still providing sufficient infusion of resin and sufficient strength in the final product.

As illustrated in FIGS. 2-7, the fiber reinforced portion 200, 201, 202 and 203 can comprise a variety of configurations. For example, with reference to FIGS. 1 and 2, in some embodiments, the fiber reinforced portion 200 of the wind turbine 100 rotor blade 114 can comprise a continuous fiber mat 220 adjacent a prefabricated layer 210. The fiber reinforced portion 200 can further comprise a structural layer adjacent the continuous fiber mat 210 opposite the prefabricated layer 210. In some embodiments, such as that illustrated in FIG. 2, the structural layer can comprise a second prefabricated layer 212.

In other embodiments, such as that illustrated in FIG. 3, the structural layer 230 of the reinforced portion 201 may simply comprise reinforcing fibers such as continuous glass fibers or continuous carbon fibers. The reinforced portion 201 may even comprise a second prefabricated layer (not illustrated) adjacent the structural layer 230 opposite the continuous fiber mat 220. In these embodiments, the reinforced portion 201 may potentially comprise a second continuous fiber mat (not illustrated) between the second prefabricated layer (not illustrated) and the structural layer 230.

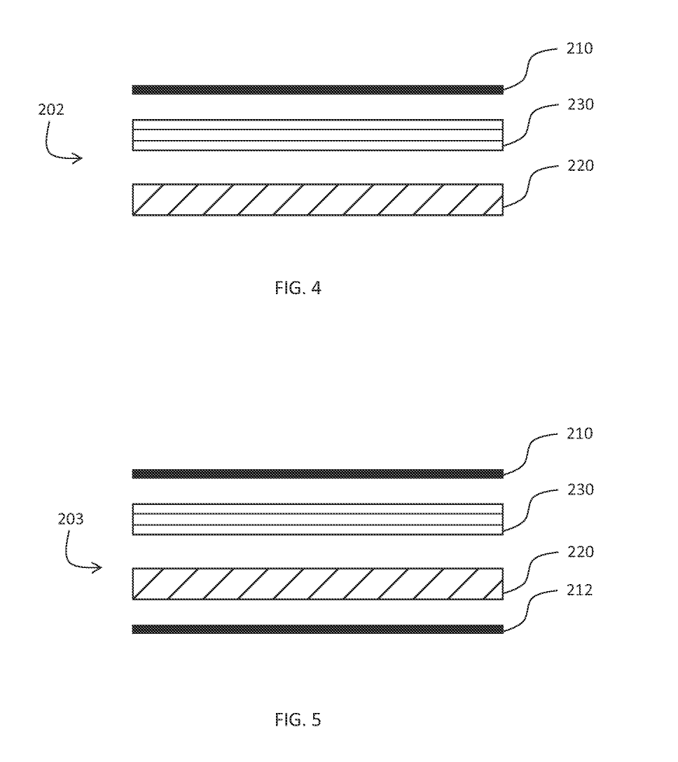

With reference to FIGS. 1 and 4, in some embodiments, the fiber reinforced portion 202 of the wind turbine 100 rotor blade 114 can comprise a structural layer 230 (e.g., continuous glass fibers or continuous carbon fibers) adjacent a prefabricated layer 210. The fiber reinforced portion 202 can further comprise a continuous fiber mat 220 adjacent the structural layer 230 opposite the prefabricated layer 210. Referring to FIGS. 1 and 5, in some embodiments, the fiber reinforced portion 203 may further comprise a second prefabricated layer 212 adjacent the continuous fiber mat 220 opposite the structural layer 230. Alternatively, in some embodiments, the fiber reinforced portion 203 may further comprise a second structural layer (not illustrated) adjacent the continuous fiber mat 220 opposite the first structural layer 230. In such embodiments, a second prefabricated layer 212 may then be adjacent the second structural layer (not illustrated) opposite the continuous fiber mat 220.

While specific embodiments of fiber reinforced portions have been disclosed herein (e.g., FIGS. 2-5), it should be appreciated that additional or alternative embodiments may also be realized. Referring to FIG. 1, the fiber reinforced portions may thereby comprise any portion of the wind turbine 100 rotor blade 114. For example, in some embodiments, the fiber reinforced portion may comprise a root portion 116 of the rotor blade 114. Thus, when the root portion needs to build up thickness during manufacturing to withstand the stresses imposed during operation, the fiber reinforced portions disclosed herein can allow for efficient assembly of the root portion 116 while still providing sufficient infusibility of the polymeric resin. In other embodiments, additional or alternative portions of the rotor blade 114 may comprise fiber reinforced portions such as the tip portion or an portion about the rotor blades 114 length.

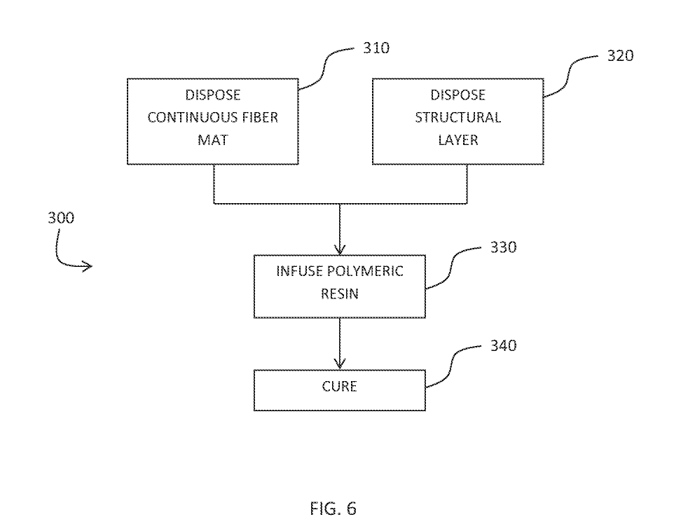

Referring now also to FIG. 6, a method 300 of manufacturing a fiber reinforced portion (200, 201, 202 and 203 in FIGS. 2-5) is illustrated. The method 300 comprises disposing a continuous fiber mat (element 220 in FIGS. 2-5) in step 310 and disposing a structural layer (element 230 in FIGS. 2-5) in step 320. The continuous fiber mat and the structural layer may be disposed in a variety of configurations with respect to each other and potentially a prefabricated layer (element 210 in FIGS. 2-5). For example, the continuous fiber mat may be disposed adjacent the prefabricated layer in step 310 prior to disposing the structural layer adjacent the continuous fiber mat (opposite the prefabricate layer) in step 310. Alternatively, the continuous fiber mat and the structural layer may be disposed adjacent each other in steps 310 and 320 simultaneously. In such embodiments, a prefabricated layer or other additional layer (e.g., continuous fiber mat or structural layer) may be disposed on either side of the first continuous fiber may or the first structural layer. In some embodiments, steps 310 and/or 320 may be repeated so that the fiber reinforced portion comprises multiple layers of the continuous fiber mat and/or structural layer. It should be appreciated that steps 310 and 320 may thereby occur in any order and for any repetitions so that the fiber reinforced portion can comprise a variety of different configurations (such as those exemplary illustrated in FIGS. 2-5 and discussed above).

The method 300 then comprises infusing polymeric resin in step 330 and subsequently curing in step 340. The resin may be infused in step 330 using any suitable process that allows the resin to fully infuse throughout the at least continuous fiber mat such as using vacuum bags, pressure differentials or the like. In some embodiments, where the structural layer comprises glass fibers or carbon fibers, the resin may also be infused into said structural layer. In some embodiments, where a prefabricated layer (already comprising cured resin) is present in the fiber reinforced portion, the resin infused in step 330 may infuse up to the surface of the prefabricated layer to effectively bond the different layers together upon curing in step 340. Curing can then occur in step 340 at any temperature and for any amount of time that allows infused polymeric resin to harden thereby providing a fiber reinforced portion having a solid structure. The curing in step 340 may also occur at any ramp rate (including both increases and decreases in temperature, or combinations thereof) and can occur in any suitable environment (e.g., an open or inert atmosphere).

It should now be appreciated that fiber reinforced portions may be manufactured using a variety of combinations of continuous fiber mats, structural layers and/or prefabricated layers. The combination of such layers can both allow for suitable infusibility of polymeric resin during manufacturing while also providing the necessary structural strength once the fiber reinforced portion is cured. The fiber reinforced portions may thereby build up thickness and strength through a more efficient and reproducible manufacturing process. Furthermore, the reinforced portion may then be utilized for a variety of different portions of a wind turbine rotor blade or wherever the increased strength may be employed.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method of manufacturing a fiber reinforced portion of a wind turbine rotor blade, the method comprising:
disposing a continuous fiber mat adjacent a prefabricated layer, wherein the continuous fiber mat comprises randomly arranged reinforcing fibers and wherein the prefabricated layer comprises reinforcing fibers and a cured polymeric resin;
disposing a structural layer adjacent the continuous fiber mat opposite the prefabricated layer, wherein the structural layer comprises reinforcing fibers;
infusing a polymeric resin through at least the continuous fiber mat; and,
curing the resin to form the fiber reinforced portion of the wind turbine rotor blade.

2. The method of claim 1, wherein the structural layer comprises another prefabricated layer comprising reinforcing fibers and cured polymeric resin.

3. The method of claim 1, wherein the structural layer comprises continuous glass fibers or continuous carbon fibers.

4. The method of claim 3 further comprising disposing a second prefabricated layer adjacent the structural layer opposite the continuous fiber mat prior to infusing the polymeric resin.

5. The method of claim 4 further comprising disposing a second continuous fiber mat comprising randomly arranged reinforcing fibers between the second prefabricated layer and the structural layer.

6. The method of claim 1, wherein the structural layer has a higher reinforcing fiber density than the continuous fiber mat.

7. The method of claim 1, wherein the fiber reinforced portion comprises a root portion of the wind turbine rotor blade.

8. A method of manufacturing a fiber reinforced portion of a wind turbine rotor blade, the method comprising:
disposing a structural layer adjacent a prefabricated layer, wherein the structural layer comprises reinforcing fibers and wherein the prefabricated layer comprises reinforcing fibers and a cured polymeric resin;
disposing a continuous fiber mat adjacent the structural layer opposite the prefabricated layer, wherein the continuous fiber mat comprises randomly arranged reinforcing fibers;
infusing a polymeric resin through at least the continuous fiber mat; and,
curing the resin to form the fiber reinforced portion of the wind turbine rotor blade.

9. The method of claim 8, wherein the structural layer comprises continuous glass fibers or continuous carbon fibers.

10. The method of claim 8, wherein the structural layer has a higher reinforcing fiber density than the continuous fiber mat.

11. The method of claim 8 further comprising disposing a second prefabricated layer adjacent the continuous fiber mat opposite the structural layer prior to infusing the polymeric resin.

12. The method of claim 8 further comprising disposing a second structural layer adjacent the continuous fiber mat opposite the first structural layer prior to infusing the polymeric resin.

13. The method of claim 12 further comprising disposing a second prefabricated layer adjacent the second structural layer opposite the continuous fiber mat.

14. The method of claim 8, wherein the fiber reinforced portion comprises a root portion of the wind turbine rotor blade.

15. A wind turbine rotor blade comprising a fiber reinforced portion, the fiber reinforced portion comprising:
a prefabricated layer comprising reinforcing fibers and a cured polymeric resin;
a continuous fiber mat adjacent the prefabricated layer, the continuous fiber mat comprising randomly arranged reinforcing fibers; and,
a polymer resin infused through at least the continuous fiber mat.

16. The wind turbine rotor blade of claim 15, wherein the fiber reinforced portion further comprises a structural layer adjacent the continuous fiber mat, wherein the structural layer comprises reinforcing fibers.

17. The wind turbine rotor blade of claim 16, wherein the structural layer comprises continuous glass fibers or continuous carbon fibers.

18. The wind turbine rotor blade of claim 16, wherein the structural layer has a higher reinforcing fiber density than the continuous fiber mat.

19. The wind turbine rotor blade of claim 15, wherein the fiber reinforced portion further comprises a second prefabricated layer adjacent the continuous fiber mat opposite the first prefabricated layer.

20. The wind turbine rotor blade of claim 15, wherein the fiber reinforced portion comprises a root portion of the wind turbine rotor blade.
